(19) United States
(12) Patent Application Publication
(10) Pub. No.: US 2014/0152598 A1
(43) Pub. Date: Jun. 5, 2014

(54) PORTABLE ELECTRONIC SYSTEM AND TOUCH FUNCTION CONTROLLING METHOD THEREOF

(71) Applicant: ASUSTeK COMPUTER INC., Taipei (TW)

(72) Inventors: Hung-Jan TU, Taipei (TW); Chi-Wen YANG, Taipei (TW)

(73) Assignee: ASUSTeK COMPUTER INC., Taipei (TW)

(21) Appl. No.: 14/090,675

(22) Filed: Nov. 26, 2013

(30) Foreign Application Priority Data
Dec. 4, 2012 (TW) 101145415

(51) Int. Cl. G06F 3/041

(52) U.S. Cl. CPC G06F 3/041
USPC 345/173

(57) ABSTRACT

A portable electronic system includes a display module, a touch input module, and a control module. The touch input module includes a touch panel, a transceiver control unit, and a touch processing unit. The transceiver control unit is coupled with the touch panel to transmit signal. The touch processing unit is coupled with the transceiver control unit. The control module includes a sensor and a control unit. The sensor detects an open or closed state of the display module to output a sensing signal. The control unit is coupled with the sensor to enable or disable the touch input module according to the open or closed state of the display module when the portable electronic system is at an operating mode.

### CROSS-REFERENCE TO RELATED APPLICATION

This application claims the priority benefit of Taiwan application serial No. 101145415, filed on Dec. 4, 2012. The entirety of the above-mentioned patent application is hereby incorporated by reference herein and made a part of specification.

### BACKGROUND OF THE INVENTION

1. Field of the Invention

The disclosure relates to a portable electronic system and a touch function controlling method thereof.

2. Description of the Related Art

Electronic devices with touch functions are more popular recently. The touch function is also integrated into notebook computers for users to operate the computers more instinctively.

Although the notebook computers with touch screens may be better operability, the touch screen may be mis-touched easily. More specifically, when a notebook is closed, an unexpected action may be generated due to a capacity coupling effect between the panel and the top casing, especially when the top casing is made by metal.

To solve the problem, thick cushions are disposed on the bezel of notebook computer to form a gap between the panel and the top casing when the panel is closed currently. However, it is not compliance with the trend of light and thin of notebook design.

### BRIEF SUMMARY OF THE INVENTION

A portable electronic system is provided, which includes a display module, a touch input module, a control module. The touch input module includes a touch panel, a transceiver control unit, and a touch processing unit. The transceiver control unit is coupled with the touch panel to transmit signals. The touch processing unit is coupled with the transceiver control unit. The control module includes a sensor and a control unit. The sensor detects the open or closed state of the display module to output a sensing signal. The control unit is coupled with the sensor and determines to enable or disable the touch input module according to the sensing signal corresponding to the open or closed state.

A touch function controlling method of a portable electronic system is provided. The touch function controlling method includes obtaining open or closed information of the display module by the control module; determining whether the display module is closed according to the open or closed information; disabling the touch input module when the display module is closed.

Another touch function controlling method of a portable electronic system is provided. The touch function controlling method includes: determining whether an event of a touch input generated by a touch input module exceeds a threshold value; disabling the touch input module when the event of the touch input exceeds the threshold value; maintaining the touch input module normal operating when the event of the touch input does not exceed the threshold value.

### BRIEF DESCRIPTION OF THE DRAWINGS

FIG. 1A is a three-dimensional schematic diagram showing an portable electronic system in an open state in an embodiment;

FIG. 1B is a three-dimensional schematic diagram showing a portable electronic system in an closed state in an embodiment;

FIG. 2 to FIG. 5 are system block diagrams of a portable electronic system in an embodiment;

FIG. 6 to FIG. 7 are flow charts showing a touch function controlling method of a portable electronic system in an embodiment; and

FIG. 8 is a flow chart showing a touch function controlling method of a portable electronic system in an embodiment.

### DETAILED DESCRIPTION OF THE EMBODIMENTS

These and other features, aspects and advantages of the present disclosure will become better understood with regard to the following description, appended claims, and accompanying drawings.

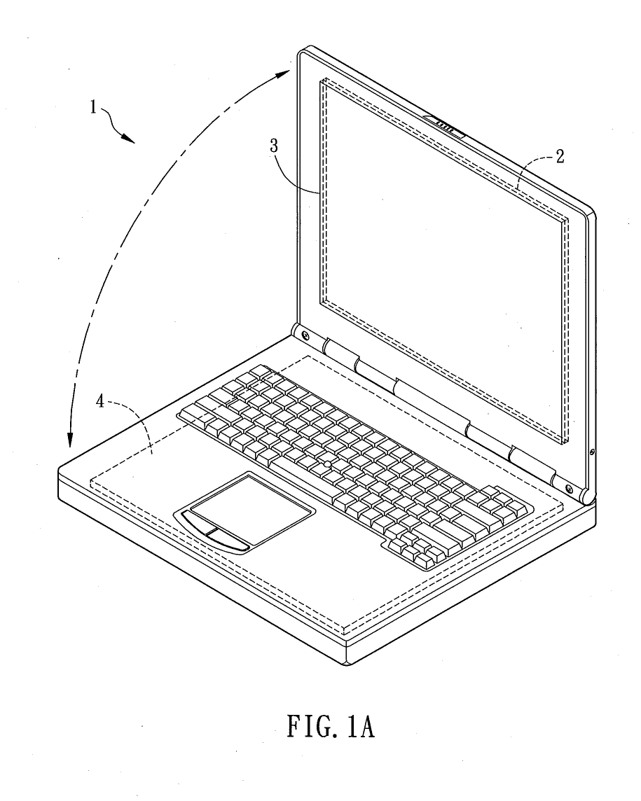

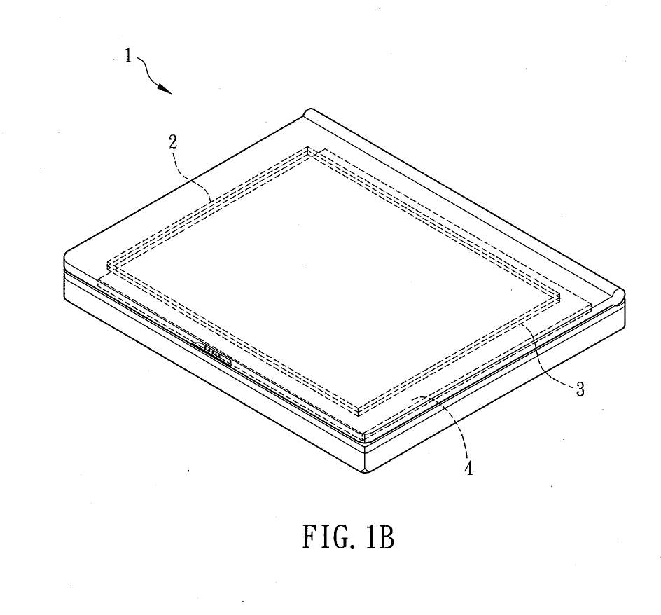

Please refer to FIG. 1A and 1B. FIG. 1A is a three-dimensional schematic diagram showing a portable electronic system in an open state; FIG. 1B is a three-dimensional schematic diagram showing the portable electronic system in a closed state. A portable electronic system 1 includes a display module 2, a touch input module 3, and a control module 4. The portable electronic system 1 may be a notebook computer which is not limited herein. The display module 2 includes a display panel, such as a liquid crystal display panel (LCD panel) or an organic light emitting diode display panel (OLED panel). The touch input module 3 includes a touch panel, such as a capacitive touch panel or a resistive touch panel. The touch input module 3 is disposed on the display module 2, which form a touch panel.

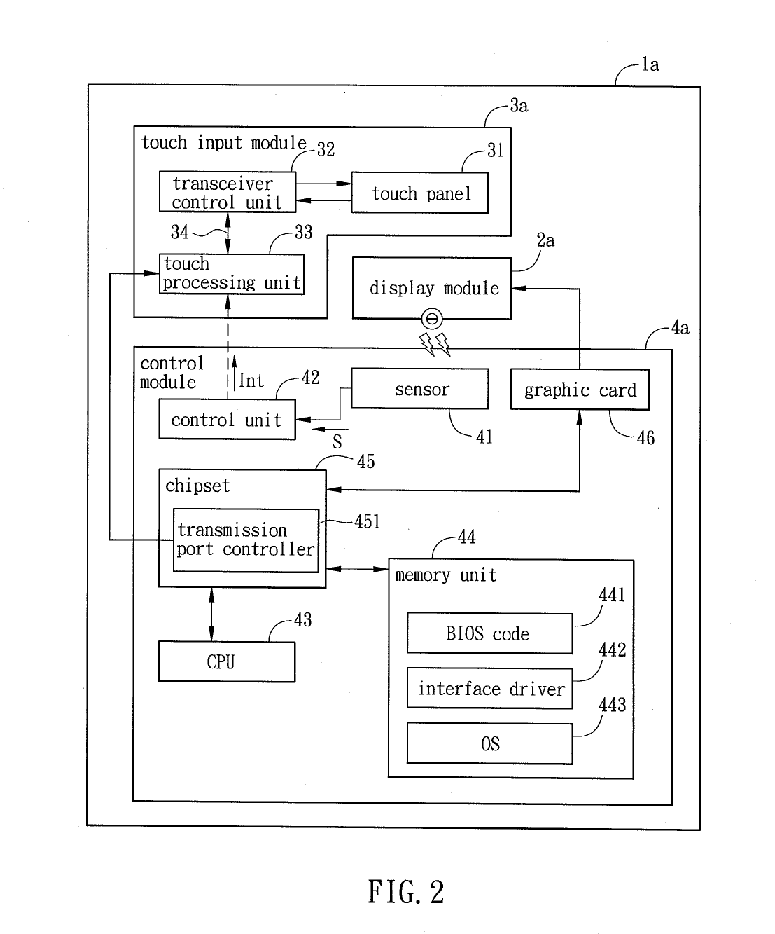

Please refer to FIG. 2, which is a block diagram of the portable electronic system. The portable electronic system 1 a includes a display module 2a, a touch input module 3a and a control module 4a.

The control module 4a includes a sensor 41, a control unit 42, a memory Unit 44, a CPU 43, a graphic card 46, and a chipset 45.

The memory unit 44 stores a Basic Input Output System (BIOS) code 441, an interface driver 442, and an operating system (OS) 443. The codes and the OS are executed by the CPU 43. The system state of the portable electronic system 1a is controlled by the OS 443. The interface driver 442 is used for driving the touch input module 3a to normally operate so that the OS 443 can correctly read the touch input instructions generated by the touch input module 3a.

The CPU 43 is an operation center for executing kinds of operations. The graphic card 46 is used for processing images and outputting the result to the display module 2a according to instructions of the OS 443. The chipset 45 may be a combination of a south bridge and a north bridge, and it is used as a connecting and a communicating bridge among the CPU 43, the graphic card 46, the memory unit 44, and other hardware components. The chipset 45 may further include a transmission port controller 451 to be coupled with the touch input module 3a via a bus corresponding to the transmission port controller 451. The transmission port controller 451 may be a universal serial bus controller (USB Controller). For example, when the touch input module 3a generates a touch signal due to a touch event from an external object, the touch signal is transmitted from the touch input module 3a to the chipset 45 via the bus, and the OS may operate according to the touch signal and generate corresponding result.

The sensor 41 detects an open or closed state of the display module 2a to output a sensing signal S. The control unit 42 is coupled with the sensor 41 and determines to enable or disable the touch input module 3a according to the sensing signal S corresponding to the open or closed state. The sensor 41 may be a magnetic sensor, an optical sensor, or a pressure sensor, and it is used for sensing the location of the display module 2a. The control unit 42 may be an embedded controlling system, and it may be integrated into a chip or a circuit board.

When the sensor 41 detects that the display module 2a is closed, the sensor 41 sends the sensing signal S, representing that the display module is closed, to the control unit 42, and the control unit 42 disables the touch input module 3a according to the sensing signal S, therefore, the touch input function is disabled. When the sensor 41 detects the display module 2a is opened, the sensor 41 sends the sensing signal S, representing that the display module is open, to the control unit 42, and the control unit 42 enables the touch input module 3a according to the sensing signal S, therefore, the touch input function is enabled.

The touch input module 3a includes a touch panel 31, a transceiver control unit 32, a touch processing unit 33, and a bus 34. The touch processing unit 33 communicates with the transceiver control unit 32 via the bus 34. The bus 34 may be a SM Bus, or an I2C Bus. The touch panel 31 is used for receiving the touch event from an external object and generating a touch signal. The transceiver control unit 32 is coupled with the touch panel 31 to transmit touch signals. The touch processing unit 33 may be a microprocessor, which is coupled with the transceiver control unit 32 and the control module 4a. The touch processing unit 33 is controlled by the control module 4a to disable or enable the transceiver control unit 32 so as to disable or enable touch input function of the touch input module 3a.

In practice, the control unit 42 may output an interrupt signal Int according to the sensing signal S corresponding to the open or closed state. The touch processing unit 33 coupled with the control unit 42 enables or disables the transceiver control unit 32 according to the interrupt signal Int. In an embodiment, after the control unit 42 receives the sensing signal S representing that the display module is closed, which sends the interrupt signal Int to the touch processing unit 33 to disable the touch processing unit 33. In an embodiment, after the control unit 42 receives the sensing signal S representing that the display module is closed, which controls the touch processing unit 33 to send a disable command to the transceiver control unit 32 to disable the touch input function of the touch input module 3a. The way of disabling the touch input module 3a can be achieved by stopping the touch processing unit 33 transceiving signals, stopping the transceiver control unit 32 receiving signals from the touch panel 31, stopping the transceiver control unit 32 transmitting signals to the touch panel 31, or stopping the transceiver control unit 32 communicating with the touch panel 31.

Additionally, the touch input module 3a may determine whether to transmit the touch signal generated by the touch panel 31 according to a threshold value of a touch condition (such as the number of effective points of the touch input or the area of the touch input) set by the touch processing unit 33. For example, when the display module 2a is closed and the received touch condition of the touch panel 31 exceeds the threshold value at a time, the touch processing unit 32 does not transmit the touch signal.

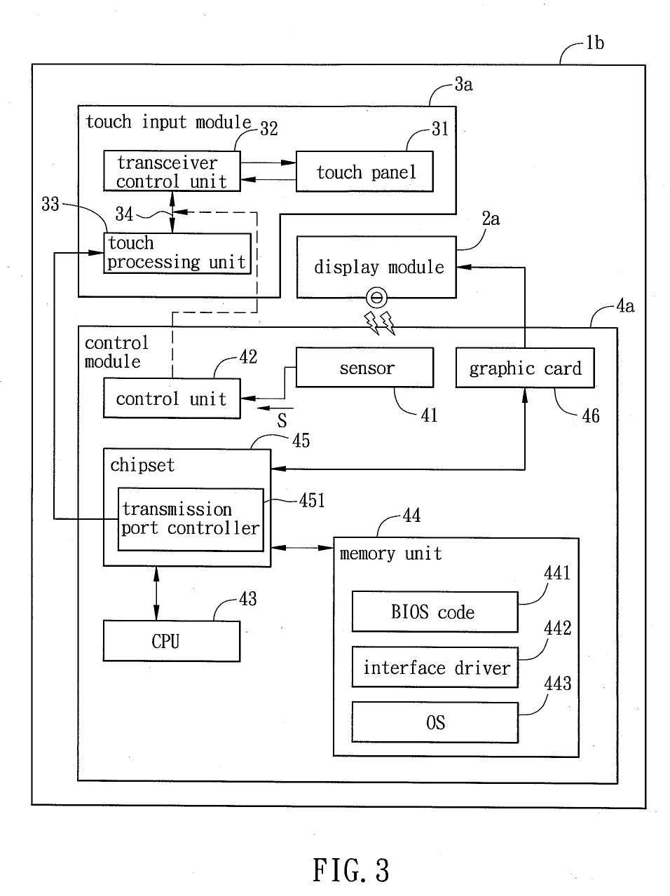

Please refer to FIG. 3, which is a block diagram of a portable electronic system. In the portable electronic system 1b, the transceiver control unit 32 is coupled with the control unit 42 via the bus 34. The control unit 42 enables or disables the transceiver control unit 32 according to the sensing signal S corresponding to the open or closed state of the display module 2a. That is, the control module 4a may stop the transceiver control unit 32 transmitting signal with the touch panel 31 via the bus 34 of the transceiver control unit 32. The way of disabling the touch function may be achieved by disabling the touch input module 3a as described in embodiment of FIG. 2.

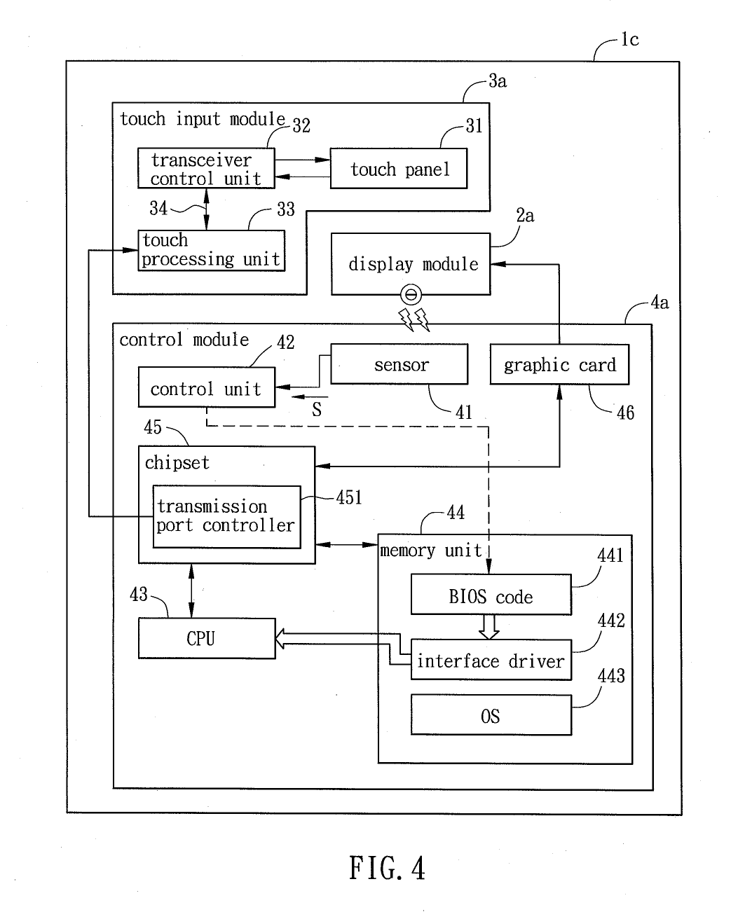

Please refer to FIG. 4, which is a block diagram of a portable electronic system. When the control unit 42 receives the sensing signal S (which represents that the display module is closed) sent by the sensor 41, the control unit 42 triggers the BIOS code 441 to inform interface driver 442 of the touch input module 3a according to the sensing signal S, and the interface driver 442 sends an instruction used for disabling the touch input module Sato the CPU 43 to disable the touch input module 3a.

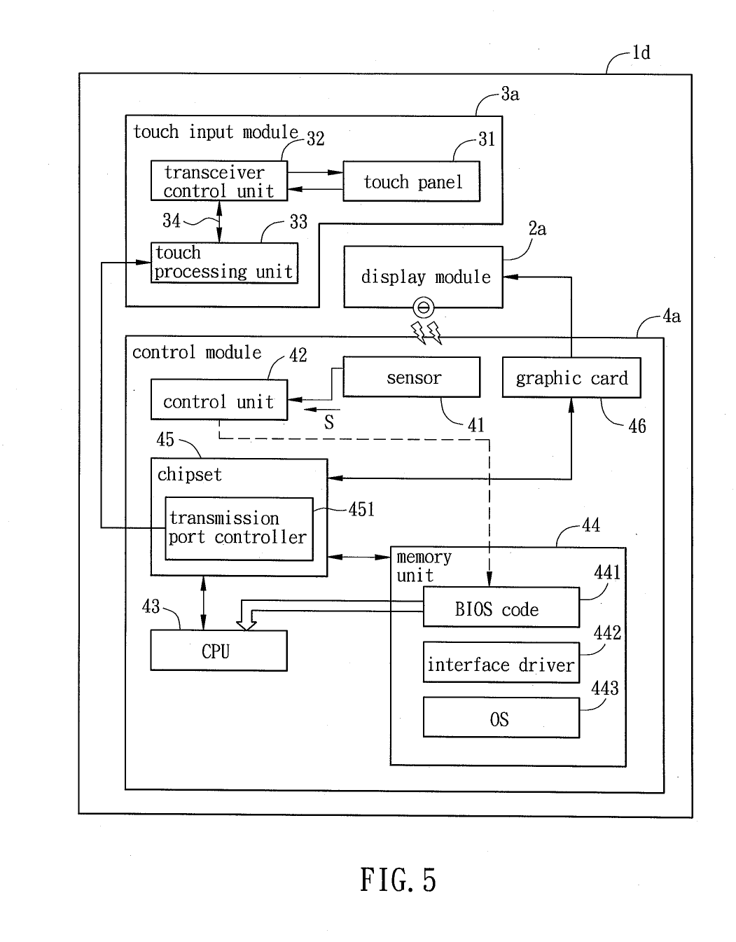

Please refer to FIG. 5, which is a block diagram of the portable electronic system. The chipset 45 communicates with the touch input module 3a via the transmission port controller 451.

When the control unit 42 receives the sensing signal S (which represents that the display module is closed) sent by the sensor 41, the control unit 42 sends an instruction to inform the CPU 43 according to the sensing signal S which triggers the BIOS code 441, and then the CPU 43 disables the transmission port controller 451, which make signal can not transmit between the touch input module 3a and chipset 45 to disable the touch input function.

In embodiments of FIG. 2 to FIG. 4, when the sensor 41 senses that the display module 2a is open, the sensor 41 transmits the sensing signal S representing that the display module is open to the control unit 42, and the control unit 42 may enable the touch input module 3a according to the sensing signal S to enable the touch input function.

In embodiment of FIG. 5, when the display module 2a is open, the chipset 45 re-enumerates the transmission port controller 451 to make the transmission port controller 451 normally operate again, therefore, the touch input function may normally operate.

In the embodiments of FIG. 2 to FIG. 5, if the display module is closed and the portable electronic system is at a non-operating mode, such as a sleep or a standby state, the touch input function is closed, thus it does not need to disable the touch input module 3a as mentioned above.

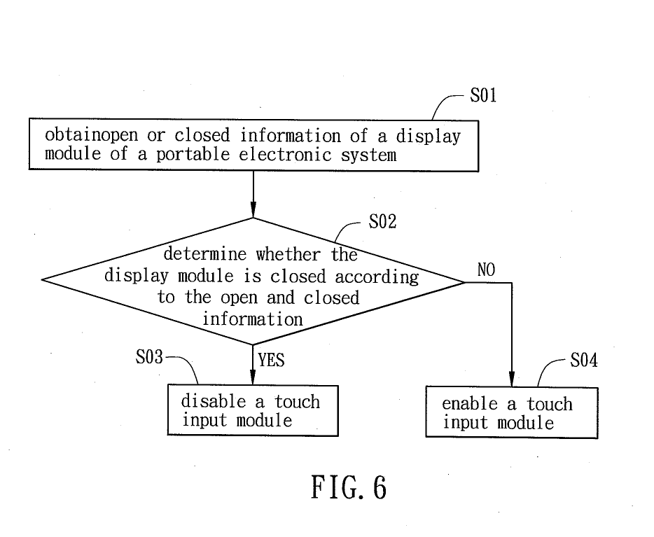

Please refer to FIG. 6, which is a flow chart showing a touch function controlling method of a portable electronic system.

In step S01, obtaining open or closed information of the display module by the control module. For example, if the state of the display module is changed from open to closed, it is determined that the display module is closed, otherwise, it is determined that the display module is opened.

In step S02, determining whether the display module is closed according to the open or closed information.

In step S03, disabling a touch input module of the display module when the display module is closed.

In step S04, enabling the touch input module to make the portable electronic system can normally operate touch function when the display module is open.

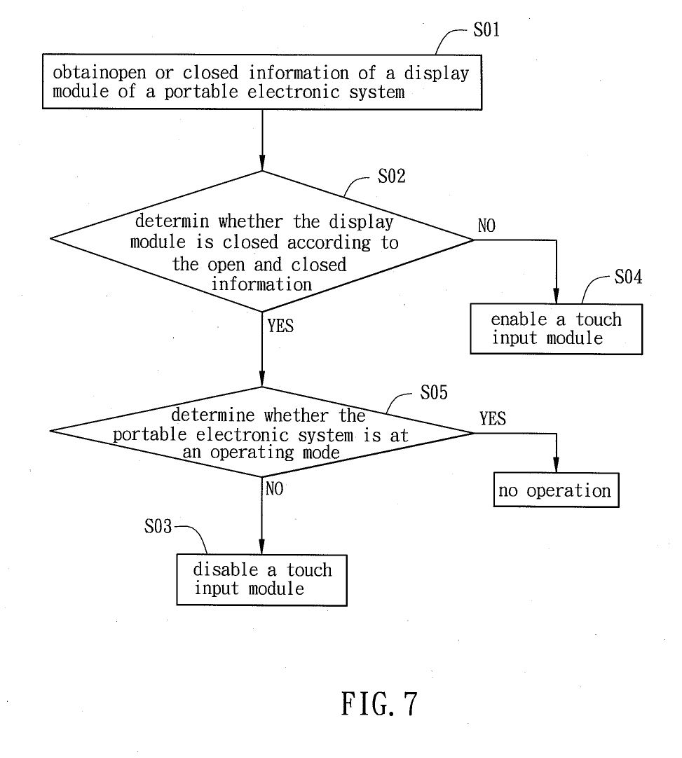

Please refer to FIG. 7, which is a flow chart showing a touch function controlling method of a portable electronic system. The touch function controlling method further includes step S05. When the display module is closed, determining whether the portable electronic system is at an operating mode in step S05, in which the operating mode represents that the portable electronic system is at a normal operating mode and the non-operating mode represents that the portable electronic system is at a sleeping mode or powered off. Thus when the portable electronic system is at the non-operating mode, it does not need to disable the touch input function. In step S03, disabling the touch input module when the portable electronic system is at the operating mode.

When the power of the display module is shut down, whether the touch input function is disabled is further checked. If not, the touch input module is disabled to disable the touch input function. However when the power of the display module is turned on, whether the touch input function is enabled is checked. If not, the touch input function is enabled.

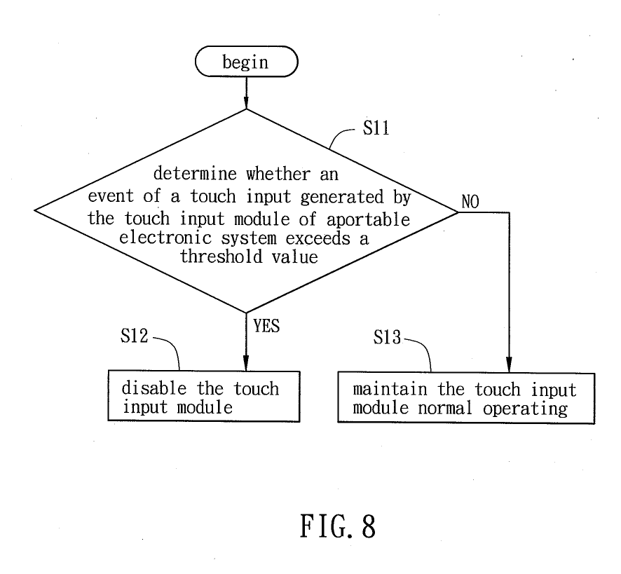

Please refer to FIG. 8, which is a flow chart showing a touch function controlling method of a portable electronic system. The touch function controlling method includes steps S11 to S13.

In step S11, determining whether an event of a touch input generated by the touch input module of a portable electronic system exceeds a threshold value, wherein the touch input module is disposed on the display module.

In step S12, disabling the touch input module when the event of the touch input exceeds the threshold value.

In step S13, maintaining the touch input module normally operating when the event of the touch input does not exceed the threshold value.

The event of the touch input is the number of points of the touch input or the area of the touch input at a time. For example, when the display module is closed, the number of touch points or a touch area between the touch input module and the casing or keyboard of the portable electronic system may increase, and it may cause that the number of effective points of the touch input or the area of the touch input increases. Therefore, by determining whether the number of points of the touch input or the area of the touch input exceeds the setting threshold value to determine whether the display module is closed. If the number of points of the touch input or the area of the touch input exceeds the threshold value, it determines that the display module is closed, and the touch input module is disabled to disable the touch function. If the number of points of the touch input or the area of the touch input does not exceed the threshold value, the touch input module maintains operating normally.

In sun, the portable electronic system and the touch function controlling method in the embodiments can make the portable electronic system have a function of preventing a mistouch without increasing the thickness of the portable electronic system. Therefore, unexpected operations would not generate due to the mistouch input signal when the display module is closed.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A portable electronic system, comprising:
a display module;
a touch input module disposed on the display module; and
a control module coupled with the touch input module for detecting an open and closed state of the display module,
wherein the control module enables or disables the touch input module according to the open or closed state of the display module when the portable electronic system is at an operating mode.

2. The portable electronic system according to claim 1, wherein the touch input module further comprises:
a transceiver control unit; and
a touch processing unit coupled with the transceiver control unit,
wherein the control module is coupled with the touch processing unit and outputs an interrupt signal to disable the touch input module when the display module is closed.

3. The portable electronic system according to claim 2, wherein the control module disables the touch input module by disabling the touch processing unit.

4. The portable electronic system according to claim 2, wherein the control module sends a disable signal to disable the transceiver control unit after the touch processing unit receives the interrupt signal.

5. The portable electronic system according to claim 1, wherein the control module further comprises:
a sensor detecting the open or closed state of the display module and outputting a sensing signal corresponding to the open or closed state;
a control unit coupled with the sensor and receiving the sensing signal;
a memory unit storing a BIOS code and an interface driver; and
a central processing unit (CPU) used for executing the BIOS code and the interface driver;
wherein the control unit triggers the BIOS code according to the sensing signal to inform the interface driver to send an instruction to the CPU, and the CPU disables the touch input module according to the instruction.

6. The portable electronic system according to claim 1, wherein the control module further comprises:
a sensor used for detecting the open or closed state of the display module and outputting a sensing signal according to the open or closed state;
a control unit coupled with the sensor and receiving the sensing signal;
a memory unit storing a BIOS code;
a CPU used for executing the BIOS code; and
a chipset including a transmission port controller for controlling the signal transmission among the chipset, the CPU and the touch input module;
wherein the control unit triggers the BIOS code according to the sensing signal to send an instruction to inform the CPU, and the CPU disables the transmission port controller according to the instruction.

7. A touch function controlling method of a portable electronic system, wherein the portable electronic system includes a display module, a touch input module and a control module, and the touch input module is disposed on the display module, the touch function controlling method comprising:
obtaining open and closed information of the display module by the control module;
determining whether the display module is open or closed according to the open or closed information;
disabling the touch input module when the display module is closed; and
enabling the touch input module when the display module is open.

8. The touch function controlling method according to claim 7, further comprising:
determining whether the portable electronic system is at an operating mode when the display module is closed; and
disabling the touch input module when the portable electronic system is at the operating mode.

9. A touch function controlling method of a portable electronic system, wherein the portable electronic system includes a display module and a touch input module, the touch input module includes a touch panel, a transceiver control unit, and a touch processing unit, and the touch input module is disposed on the display module, the touch function controlling method comprising:
determining whether an event of a touch input generated by the touch input module exceeds a threshold value;
disabling the touch input module when the event of the touch input exceeds the threshold value; and
maintaining the touch input module normally operating when the event of the touch input without exceeding the threshold value.

10. The touch function controlling method according to claim 9, wherein the event of the touch input is the number of points of the touch input or the area of the touch input.
